(19) United States
(12) Patent Application Publication
(10) Pub. No.: US 2011/0277704 A1
(43) Pub. Date: Nov. 17, 2011

(54) PET BANDANA

(76) Inventor: Kathereen E. Abbiegayle Shafer, Corsicana, TX (US)

(21) Appl. No.: 13/106,605

(22) Filed: May 12, 2011

Related U.S. Application Data
(60) Provisional application No. 61/334,335, filed on May 13, 2010.

(51) Int. Cl. A01K 29/00

(52) U.S. Cl. 119/863

(57) ABSTRACT

The present invention is a fabric pet bandana utilized by a pet that includes an inverted isosceles triangle shaped body with a top base, two sides, a front and a pair of ties disposed on the sides, an elongated rectangular strip attached to the top base of the triangular shape body and an aperture disposed on the middle portion of the elongated rectangular strip. There is also a ring intersected through the aperture to removably accommodate a pet leach or clip and one or more indicia disposed on the front of the triangular shaped body. A second embodiment of the present invention includes a triangular shaped body, an elongated rectangular strip that includes an elongated opening and one or more indicia disposed on the front of the inverted triangular shaped body. The indicia can be a logo or decorative indicia.

This application claims priority to U.S. Provisional Application 61/334,335 filed on May 13, 2010, the entire disclosure of which is incorporated by reference.

### TECHNICAL FIELD & BACKGROUND

It is an object of the present invention to provide a pet bandana that solves the problem of a bandana tied around a pet's neck and sliding down the pet's neck and choking the pet.

It is an object of the present invention to provide a pet bandana that allows the pet's collar to be slid though the top of the bandana so that it prevents choking and helps maintain its position on the pet.

It is an object of the present invention to provide a pet bandana that allows the pet's tags and license to be seen while the tags are being worn.

What is really needed is a pet bandana that solves the problem of a bandana tied around a pet's neck and sliding down the person's neck and choking the pet, that allows the pet's collar to be slid though the top of the bandana so that it prevents choking and helps maintain its position on the pet and that allows the pet's tags and license to be seen while the tags are being worn.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates a front side environmental perspective view of a pet bandana, in accordance with one embodiment of the present invention.

FIG. 1B illustrates a front perspective view of a pet bandana, in accordance with one embodiment of the present invention.

FIG. 2 illustrates a rear perspective view of a pet bandana, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

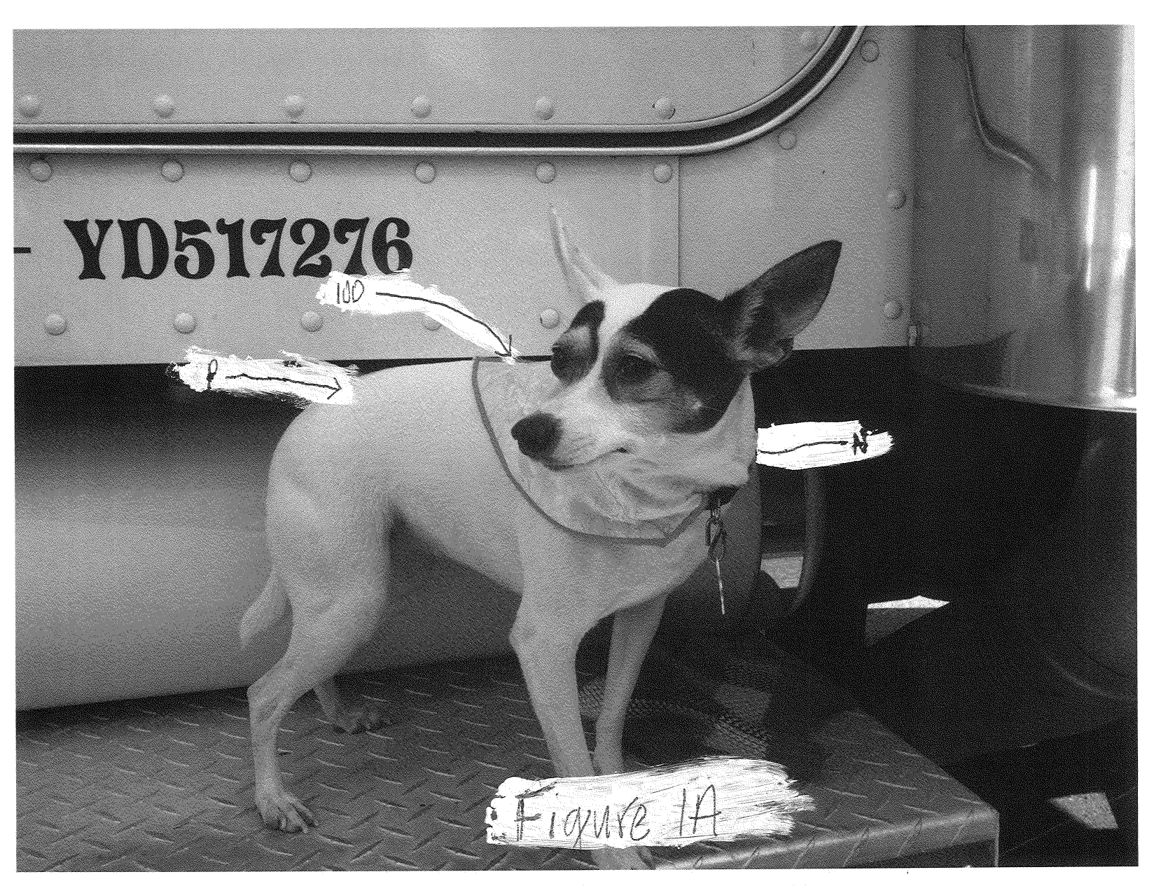

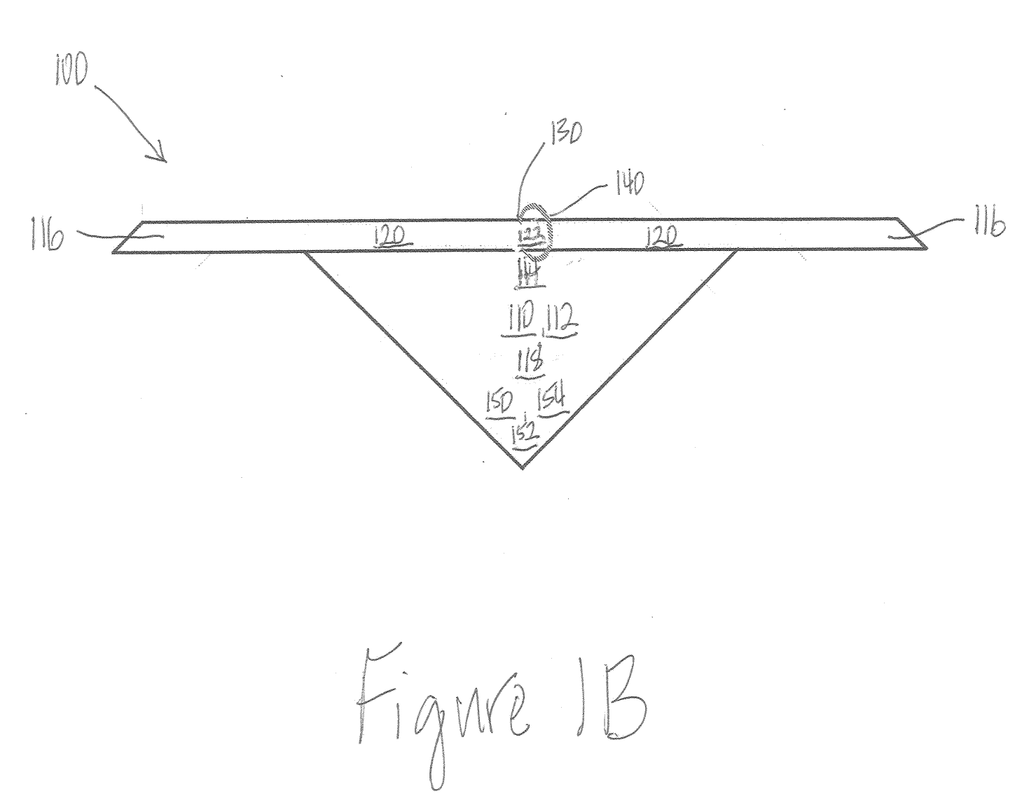

FIG. 1A illustrates a side environmental perspective view of a pet bandana 100, in accordance with one embodiment of the present invention. The pet bandana 100 is worn around the neck N of a pet P. The pet illustrated in FIG. 1A is a dog, however the pet bandana 100 can be worn by other pets such as a cat, a horse, a rabbit or other suitable pet.

FIG. 1B illustrates a front perspective view of a pet bandana 100, in accordance with one embodiment of the present invention. The pet bandana 100 includes a triangular shaped body 110, an elongated rectangular strip 120, an aperture 130, a ring 140 and one or more indicia 150. The pet bandana 100 is also reversible.

The triangular shaped body 110 is in an approximate shape of an inverted isosceles triangle 112. The triangular shaped body 110 is made of fabric or other suitable material. The elongated rectangular strip 120 is attached along the top base 114 of the triangular shaped body 110 and extends past both sides of the top base 114 forming a pair of ties 116. The ties 116 are wrapped around the neck N of the pet P and tied together in a knot or bow to secure the pet bandana 100 around the neck N of the pet P. The aperture 130 is disposed on the middle portion 122 of the elongated rectangular strip 120. The aperture 130 is a sewn reinforced d-shaped aperture but can be any type of suitable aperture. The ring 140 is intersected through the aperture 130 to accommodate a pet leach clip. The ring 140 enables relatively easy removable attachment to the pet leash clip. The indicia 150 can be a logo 152, such as a company logo or other suitable logo that is disposed on the front 118 of the triangular shaped body 110. The indicia 150 can also include decorative indicia 154 such as rhinestones, lace, jewels, embroidery or other suitable decorative indicia.

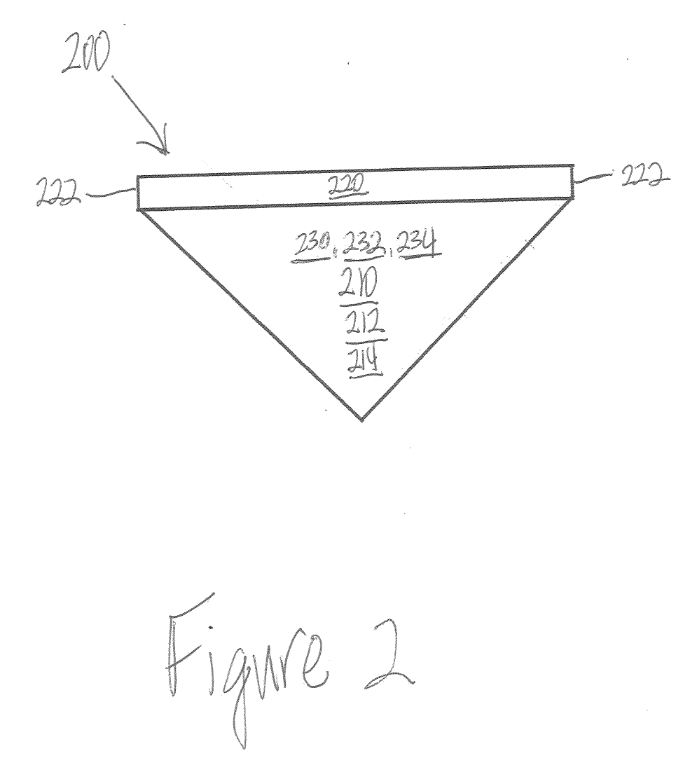

FIG. 2 illustrates a rear perspective view of a pet bandana 200, in accordance with one embodiment of the present invention. The pet bandana 200 includes a triangular shaped body 210, an elongated rectangular strip 220 and one or more indicia 230. The pet bandana 100 is also reversible.

The triangular shaped body 210 and indicia 230 are the same as the triangular shaped body 110 and indicia 150 described and illustrated in FIGS. 1A and 1B and their descriptions. The triangular shaped body 210 is in an approximate shape of an inverted isosceles triangle 212. The triangular shaped body 210 is made of fabric or other suitable material. The elongated rectangular strip 220 includes an elongated opening 222 disposed over the entire length of the triangular shaped body 210. The elongated strip 220 is folded over and sewn to the top base 114 of the triangular shaped body to form the elongated opening 222 to accommodate a pet collar that is slid through the elongated opening 222 to hold the pet bandana 200. The indicia 230 can be a logo 232, such as a company logo or other suitable logo that is disposed on the front 214 of the triangular shaped body 210. The indicia 230 can also include decorative indicia 234 such as rhinestones, lace, jewels, embroidery or other suitable decorative indicia.

The pet bandana is used to dress up pets and to keep them safe from choking on a regular tied-on bandana. The first embodiment of the pet bandana 100 comes in a variety of sizes that includes 1′ and 8.5″ in length, 1′ and 10.5″ in length, 2′ and 0.5″ in length, 2′ and, 8.5″ in length and 3′ and 0.5″ in length. The second embodiment of the pet bandana 200 comes in a variety of sizes that include 7.5″ in length, 9.5″ in length, 11.5″ in length, 1′ and 3.5″ in length, 1′ and 7.5″ in length and 1′ and 10.5″ in length. The pet bandana 100, 200 can also be custom made and fit as well.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A pet bandana utilized by a pet with a neck, comprising:
a triangular shaped body with a top base, two sides, a front and a pair of ties disposed on said sides;
an elongated rectangular strip with a middle portion attached to said top base of triangular shape body;
an aperture disposed on said middle portion of elongated rectangular strip;
a ring intersected through said aperture to accommodate a leach or clip; and
one or more indicia disposed on said front of said triangular shaped body.

2. The pet bandana according to claim 1, wherein said ties are wrapped around said neck of said pet and are tied together in a knot or a bow to secure said pet bandana around said neck of said pet.

3. The pet bandana according to claim 1, wherein said ring enables easy removable attachment to said pet leach or said clip.

4. The pet bandana according to claim 1, wherein said indicia is a logo that is disposed on said front of said triangular shaped body.

5. The pet bandana according to claim 4, wherein said indicia includes decorative indicia selected from the group consisting of rhinestones, lace, jewels or embroidery.

6. The pet bandana according to claim 1, wherein said pet is selected from the group consisting of a dog, a cat, a horse or a rabbit.

7. A fabric pet bandana utilized by a pet with a neck, comprising:
an inverted isosceles triangle shaped body with a top base, two sides, a front and a pair of ties disposed on said sides;
an elongated rectangular strip with a middle portion attached to said top base of triangular shape body;
an aperture disposed on said middle portion of elongated rectangular strip;
a ring intersected through said aperture to removably accommodate a pet leach or clip; and
one or more indicia disposed on said front of said triangular shaped body.

8. The pet bandana according to claim 7, wherein said ties are wrapped around said neck of said pet and are tied together in a knot or a bow to secure said pet bandana around said neck of said pet.

9. The pet bandana according to claim 7, wherein said ring enables easy removable attachment to said pet leach or said clip.

10. The pet bandana according to claim 7, wherein said indicia is a logo that is disposed on said front of said triangular shaped body.

11. The pet bandana according to claim 10, wherein said indicia includes decorative indicia selected from the group consisting of rhinestones, lace, jewels or embroidery.

12. The pet bandana according to claim 7, wherein said pet is selected from the group consisting of a dog, a cat, a horse or a rabbit.

13. The pet bandana according to claim 7, wherein said pet bandana is 1 foot and 8.5 inches in length, 1 foot and 10.5 inches in length, 2 feet and 0.5 inches in length, 2 feet and 8.5 inches in length or 3 feet and 0.5 inches in length.

14. A pet bandana utilized by a pet with a neck, comprising:
a triangular shaped body with an entire length and a front;
an elongated rectangular strip that includes an elongated opening disposed over said entire length of said triangular shaped body; and
one or more indicia disposed on said front of said inverted triangular shaped body.

15. The pet bandana according to claim 14, wherein said triangular shaped body is inverted isosceles triangle shaped.

16. The pet bandana according to claim 14, wherein said elongated opening accommodates a pet collar that is slid through said elongated opening to secure said pet bandana to said pet.

17. The pet bandana according to claim 14, wherein said indicia is a logo that is disposed on said front of said inverted triangular shaped body.

18. The pet bandana according to claim 17, wherein said indicia includes decorative indicia selected from the group consisting of rhinestones, lace, jewels or embroidery.

19. The pet bandana according to claim 14, wherein said pet is selected from the group consisting of a dog, a cat, a horse or a rabbit.

20. The pet bandana according to claim 14, wherein said pet bandana is 7.5 inches in length, 9.5 inches in length, 11.5 inches in length, 1 foot and 3.5 inches in length, 1 foot and 7.5 inches in length or 1 foot and 10.5 inches in length.
